(19) United States
(12) Patent Application Publication
(10) Pub. No.: US 2024/0181738 A1
(43) Pub. Date: Jun. 6, 2024

(54) DUNNAGE DEVICE JAM DETECTOR

(71) Applicant: Pregis Innovative Packaging LLC, Chicago, IL (US)

(72) Inventors: Thomas D. Wetsch, Naples, FL (US); Ken Chess, Hinsdale, IL (US); David Joyce, Naperville, IL (US)

(21) Appl. No.: 18/530,186

(22) Filed: Dec. 5, 2023

Related U.S. Application Data
(60) Provisional application No. 63/386,155, filed on Dec. 5, 2022.

(51) Int. Cl. B31D 5/00

(52) U.S. Cl. CPC B31D 5/0052; B31D 2205/0035; B31D 2205/007; B31D 2205/0082; B31D 2205/0088

(57) ABSTRACT

A device for producing dunnage includes a jam detector. The detector is mounted on an outlet chute that receives dunnage produced by a dunnage mechanism of the device. The detector is sensitive to detect a dunnage jam within the outlet chute, and is associated with the dunnage mechanism to cause the dunnage mechanism to stop driving the dunnage into the outlet chute when a jam is detected.

### CROSS-REFERENCE TO RELATED APPLICATIONS

The present application claims priority to U.S. Provisional Application No. 63/386,155, filed Dec. 5, 2022, entitled DEVICES FOR DETECTING PAPER JAMS IN SYSTEMS FOR PRODUCING DUNNAGE, which is incorporated herein by reference in its entirety.

### TECHNICAL FIELD

The present disclosure relates to systems that convert paper stock and other materials into dunnage for use as packing material, and more specifically, to devices for detecting the presence of a paper jam in the output chute of a system for producing dunnage.

### BACKGROUND

Paper-based protective packaging in the form of dunnage is produced by crumpling or otherwise deforming paper stock. More specifically, paper dunnage is produced by running a generally continuous strip of paper through a dunnage machine. The continuous strip of paper can be provided, for example, from a roll of paper or a fanfold stack of paper. The dunnage machine converts the stock material into a lower density dunnage material using, for example, opposing rollers between which the stock material is passed. The rollers grip and pull the stock material from the roll or stack, and deform the stock material as the material passes between the rollers. The resulting dunnage can be cut into desired lengths to effectively fill a void space within a container holding a product. The dunnage material may be produced on an as-needed basis for an individual or a machine performing packing operations.

The ability to smoothly and continuously feed the paper stock from the stack or roll is important to the proper and efficient operation of the dunnage machine. Jamming and other interruptions in the flow of paper stock supplied to the dunnage machine can prevent the machine from producing dunnage at the required rate, which in turn can cause delays in packaging and shipping operations that rely on a ready supply of dunnage. Frequent jamming also can result in damage to the dunnage machine, and increased maintenance costs.

Jamming of the dunnage in the outlet chute of the machine likewise can prevent the machine from producing dunnage at the required rate. Also, jamming in the outlet chute, if undetected, can result in damage to the dunnage machine and the outlet chute as the dunnage machine continues to feed dunnage in the outlet chute in presence of the jam.

### SUMMARY

In one aspect of the disclosed technology, a device for producing dunnage includes an outlet chute configured to receive the dunnage and direct the dunnage to an exit of the device. The device also includes a dunnage mechanism configured to deform a stock material into the dunnage and to drive the dunnage into and through the outlet chute to the exit. The device further includes a jam detector associated with the outlet chute and sensitive to detect a dunnage jam within the outlet chute. The jam detector is associated with the dunnage mechanism to cause the dunnage mechanism to stop driving the dunnage into the outlet chute when the jam is detected.

In another aspect of the disclosed technology, the jam detector includes a switch configured to be deflected by an accumulation of the dunnage.

In another aspect of the disclosed technology, the jam detector further includes a member having a movable surface exposed to an interior of the outlet chute, such that the accumulation of the dunnage caused by the jam depresses the movable surface so that the member deflects the switch.

In another aspect of the disclosed technology, the dunnage mechanism is further configured to crumple the stock material into the dunnage.

In another aspect of the disclosed technology, the device further includes a controller operably connected to the dunnage mechanism and the jam detector, wherein the controller is configured to control the driving of the dunnage.

In another aspect of the disclosed technology, the controller is further configured to prohibit operation of the dunnage mechanism when the jam is detected.

In another aspect of the disclosed technology, the outlet chute is further configured to shape the dunnage as the dunnage is directed to the exit of the device.

In another aspect of the disclosed technology, the outlet defines an interior volume that adjoins the exit, and a cross-sectional area of the interior volume decreases between an inlet of the interior volume and the exit.

In another aspect of the disclosed technology, a width of the interior volume decreases between the inlet of the interior volume and the exit.

In another aspect of the disclosed technology, a height of the interior volume decreases between the inlet of the interior volume and the exit.

In another aspect of the disclosed technology, the device further includes a separator configured to separate a piece of the dunnage from a remainder of the dunnage.

In another aspect of the disclosed technology, the separator includes a cutting mechanism.

In another aspect of the disclosed technology, the cutting mechanism includes a blade configured to cut the dunnage.

In another aspect of the disclosed technology, the member includes a flap.

In another aspect of the disclosed technology, the drive mechanism includes one or more rollers configured to deform the stock material into the dunnage.

In another aspect of the disclosed technology, the device further includes a gate positioned at an inlet of the outlet chute and configured to retain the piece of dunnage after the piece of dunnage has been separated by the separator.

In another aspect of the disclosed technology, the gate is movable between a first position at which the gate covers at least a portion of the inlet, and a second position; and the gate is biased toward the first position.

In another aspect of the disclosed technology, the member is further configured so that movement of the dunnage within the outlet chute in a direction transverse to a lengthwise direction of the outlet chute depresses the movable surface.

In another aspect of the disclosed technology, a dunnage system includes a unit of stock material, a supply station configured to hold the unit of stock material, and a device for producing dunnage. The device includes an outlet chute configured to receive the dunnage and direct the dunnage to an exit of the device, and a dunnage mechanism configured to deform a stock material into the dunnage and to drive the dunnage into and through the outlet chute to the exit. The device further includes a jam detector associated with the outlet chute and sensitive to detect a dunnage jam within the outlet chute. The jam detector is further associated with the dunnage mechanism to cause the dunnage mechanism to stop driving the dunnage into the outlet chute when a jam is detected.

In another aspect of the disclosed technology, the stock material includes paper.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

FIG. 1 is a top-front perspective view of a system for producing dunnage.

FIG. 2 is a top-front perspective view of a dunnage machine of the system shown in FIG. 1, with the enclosure and an outlet chute of the dunnage machine removed.

FIG. 3 is a top-front perspective view of the dunnage machine shown in FIG. 2, with the enclosure, the outlet chute, a cutting motor assembly, and a cover of the dunnage machine removed.

FIG. 4 is a front view of the dunnage machine shown in FIGS. 1-3, with the enclosure, the outlet chute, the cutting motor assembly, and the cover of the dunnage machine removed, and depicting the cutting mechanism in a home position.

FIG. 5 is a front view of the dunnage machine shown in FIGS. 1-4, with the enclosure, the outlet chute, the cutting motor assembly, and the cover of the dunnage machine removed, and depicting the cutting mechanism in an intermediate position.

FIG. 6 is a front view of the dunnage machine shown in FIGS. 1-5, with the enclosure, the outlet chute, the cutting motor assembly, and the cover of the dunnage machine removed, and depicting the cutting mechanism in an end position.

FIG. 7 is a top cross-sectional view of the system shown in FIG. 1, taken through the line “VII-VII” of FIG. 15, depicting the flap of the paper jam detection device in an inward position indicative of the absence of a paper jam within the outlet chute.

FIG. 8 is a top cross-sectional view of the system shown in FIG. 1, taken through the line “VII-VII” of FIG. 15, depicting a flap of a paper jam detection device of the system in an outward position indicative of the presence of a paper jam within an outlet chute of the system.

FIG. 9 is a magnified view of a portion of FIG. 7, depicting dunnage within the outlet chute in a jammed state.

FIG. 10 is a perspective view of a flap of the paper jam detection device shown in FIGS. 7-9, depicting an upstream edge and a back surface of the flap.

FIG. 11 is a perspective view of the flap shown in FIG. 10, depicting the upstream edge and an inward-facing surface of the flap.

FIG. 12 is a perspective view of an outlet chute of the system shown in FIG. 1, depicting an upstream end of the outlet chute.

FIG. 13 is a perspective view of system shown in FIG. 1, taken from a perspective downstream of the system and with the outlet chute removed, depicting a gate of the outlet chute in a closed position and the flap in the inward position.

FIG. 14 is a perspective view of system shown in FIGS. 1 and 13, taken from a perspective downstream of the system and depicting an interior of the outlet chute.

FIG. 15 is a side perspective view of the system shown in FIGS. 1, 13, and 14, taken through the line “XV-XV” of FIG. 8 and depicting the gate of the outlet chute in a closed position.

FIG. 16 is a side perspective view of the system shown in FIGS. 1 and 13-15, taken through the line “XV-XV” of FIG. 8 and depicting the gate of the outlet chute in an open position and a holding a piece of dunnage.

FIG. 17 is a cross-sectional view of the system shown in FIGS. 1 and 13-16, taken through the line “XVII-XVII” of FIG. 8.

FIG. 18 is a top cross-sectional view of the system shown in FIGS. 1 and 13-17, taken through the line “XVIII-XVIII” of FIG. 15, depicting the gate of the outlet chute in the closed position.

FIG. 19 is a top cross-sectional view of the system shown in FIGS. 1 and 13-18, taken through the line “VII-VII” of FIG. 15, depicting the flap of the paper jam detection device in the inward position and the gate of the outlet chute in the closed position.

### DETAILED DESCRIPTION

The following discussion omits or only briefly describes conventional features of the disclosed technology that are apparent to those skilled in the art. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the instant invention, in combination with routine experiments, to achieve other outcomes not specifically disclosed in the examples or the embodiments.

Unless otherwise specifically defined herein, all terms are to be given their broadest possible interpretation including meanings implied from the specification as well as meanings understood by those skilled in the art and/or as defined in dictionaries, treatises, etc. Unless defined otherwise, all technical and scientific terms used herein have the same meaning as commonly understood by one of ordinary skill in the art in the field of the disclosed technology. It must also be noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. Additionally, methods, equipment, and materials similar or equivalent to those described herein can also be used in the practice or testing of the disclosed technology.

Various examples of the disclosed technology are provided throughout this disclosure. The use of these examples is illustrative only, and in no way limits the scope and meaning of the invention or of any exemplified form. Likewise, the invention is not limited to any particular preferred embodiments described herein. Indeed, modifications and variations of the invention may be apparent to those skilled in the art upon reading this specification, and can be made without departing from its spirit and scope. The invention is therefore to be limited only by the terms of the claims, along with the full scope of equivalents to which the claims are entitled.

Certain relationships between features of the suppressor are described herein using the term “substantially” or “substantially equal.” As used herein, the terms “substantially” and “substantially equal” indicate that the equal relationship is not a strict relationship and does not exclude functionally similar variations therefrom. Unless context or the description indicates otherwise, the use of the term “substantially” or “substantially equal” in connection with two or more described dimensions indicates that the equal relationship between the dimensions includes variations that, using mathematical and industrial principles accepted in the art (e.g., rounding, measurement or other systematic errors, manufacturing tolerances, etc.), would not vary the least significant digit of the dimensions. As used herein, the term “substantially parallel” indicates that the parallel relationship is not a strict relationship and does not exclude functionally similar variations therefrom. As used herein, the term “substantially orthogonal” indicates that the orthogonal relationship is not a strict relationship and does not exclude functionally similar variations therefrom.

Systems for converting a high-density stock material into low-density dunnage are disclosed. The stock material can be processed by longitudinal crumple machines that form creases longitudinally in the stock material to form dunnage, or by cross crimple machines that forms creases transversely across the stock material. The supply unit of stock material can be stored in a roll (whether drawn from inside or outside the roll), a wind, a fan-folded source, or other suitable form. The stock material can be continuous or perforated. The conversion apparatus is fed the stock material from the supply unit in a first direction, which can be an anti-run out direction.

The stock material can be any suitable type of protective packaging material including, for example, flat or rolled paper stock, other dunnage and void fill materials, inflatable packaging pillows, etc. Some embodiments can use supplies of other paper or fiber-based materials in sheet form. Other embodiments can use supplies of wound fiber material such as ropes or thread. Other embodiments can use thermoplastic materials such as a web of plastic material usable to form pillow packaging material. Examples of paper used include a fan-folded supply unit having stock material with 30-inch transverse widths and/or 15-inch transverse widths. Preferably these sheets are fan folded as single layers. In other embodiments, the multiple layers of sheets can be fan folded together such that dunnage is made of superimposed sheets that are crumpled together in the conversion process.

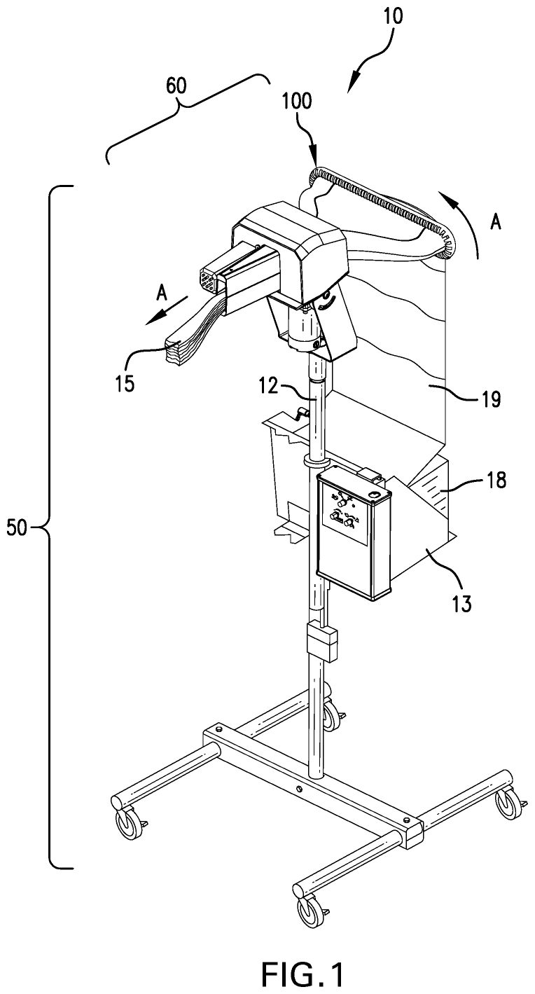

Any suitable stock material may be used. For example, the stock material can have a basis weight of about 20 lbs. to about 100 lbs. The stock material may comprise paper stock stored in a high-density configuration having a first longitudinal end and a second longitudinal end, that is later converted into a low-density configuration by the dunnage system. The stock material can be a ribbon of sheet material that is stored in a fan-fold structure as shown in FIG. 1; or in coreless rolls (not shown). The stock material can be formed or stored as single-ply or multiple plies of material. Where multi-ply material is used, a layer can include multiple plies. Other types of material can be used, such as pulp-based virgin and recycled papers, newsprint, cellulose and starch compositions, and poly or synthetic material, of suitable thickness, weight, and dimensions.

In some embodiments, the supply units of stock material may have fan-fold configurations. For example, a foldable material, such as paper, may be folded repeatedly to form a stack or a three-dimensional body. The term “three-dimensional body,” in contrast to the “two-dimensional” material, has three dimensions all of which are non-negligible. A continuous sheet, e.g., a sheet of paper, plastic, or foil, can be folded at multiple fold lines that extend transversely to a longitudinal direction of the continuous sheet, or transversely to the feed direction of the sheet. For example, folding a continuous sheet that has a substantially uniform width along transverse fold lines can form or define sheet sections that have approximately the same width. The continuous sheet can be folded sequentially, in opposite or alternating directions, to produce an accordion-shaped continuous sheet. For example, the folds may form or define sections along the continuous sheet, and the sections may be substantially rectangular.

FIG. 1 depicts an embodiment of a device 10 for producing dunnage. The device 10 is configured to process stock material 19 into dunnage 15. The device 10 includes a supply unit 18 of the stock material 19, and a dunnage apparatus 50.

The device 10 also includes a device 400 for detecting the presence of a jam of the paper dunnage 15 in an outlet chute 62 of the device 10. The device 400 is described in connection with the supply unit 18 and the dunnage apparatus 50 for illustrative purposes only. The device 400 can be used in connection with dunnage apparatuses having configurations different than that of the dunnage apparatus 50, and supply units 18 having configurations different than that of the supply unit 18.

The dunnage apparatus 50 includes a dunnage machine 60; a support 12 configured to support the dunnage machine 60; and a supply station 13 configured to hold the supply unit 18 of stock material 19.

The specific configuration of the support 12 depicted in the figures is disclosed for illustrative purposes only. The support 12 can have other configurations suitable for supporting the dunnage machine 60.

Likewise, the shelf or basket-type configuration of the supply station 13 depicted in FIG. 1, which accommodates a supply unit 18 in the form of a stack of folded stock material 19, is disclosed for illustrative purposes only. The supply station 13 can have other configurations suitable for supporting the supply unit(s) 18 in single bundles; in multiple daisy chained bundles; in a flat configuration; in a rolled configuration; and/or in a curved configuration.

The supply station 13 can support one or more of the supply units 18 of stock material 19. In applications where multiple supply units 18 are accommodated by the supply station 13, the end and beginning sheets of adjacent supply units 18 be connected together before or after being placed on the supply station 13. Connecting together or daisy-chaining multiple supply units can produce a continuous supply of stock material 19.

The stock material 19 is converted to the dunnage 15 by following a material path A through the device 10, as depicted in FIG. 1. The material path A has an inlet end where the stock material 19 is fed into the device 10, and an outlet end where the dunnage 15 exits the device 10.

FIGS. 1-6 depict the dunnage machine 60 of the device 10. The dunnage machine 60 includes an enclosure 61; the intake 100; a cutting motor assembly 201; and a feed motor 305.

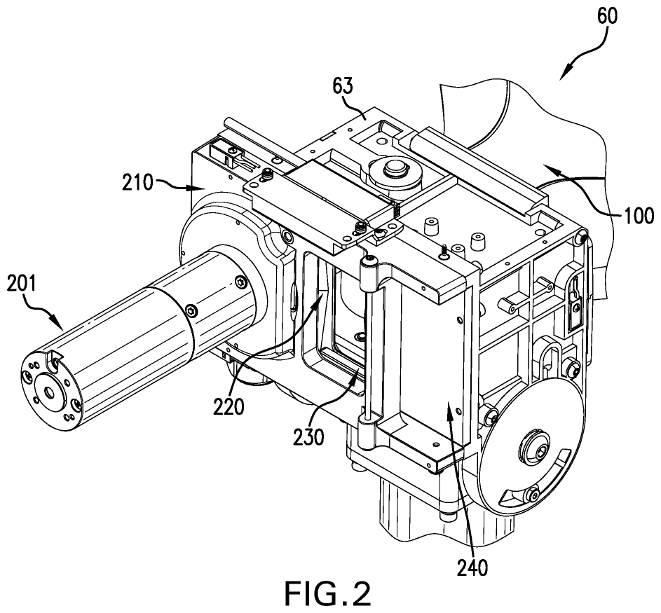

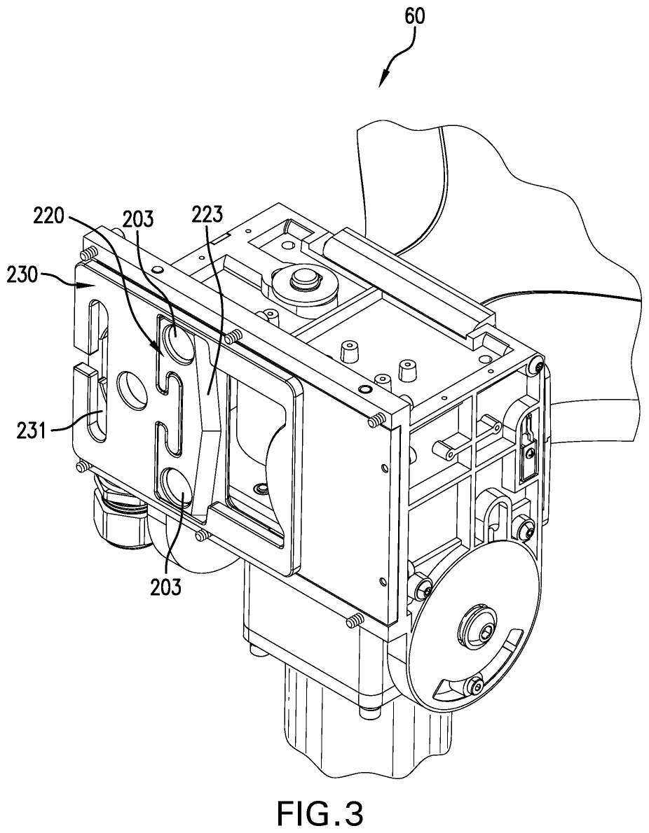

For purposes of illustration, FIGS. 2 and 3 depict the dunnage machine 60 without the enclosure 61, thus exposing a frame 63, and separator in the form of a cutting mechanism 200 of the dunnage machine 60. The intake 100 is rotatably coupled to the frame 63 through an inlet spindle (not shown). The intake 100 can be rotated upward about the inlet spindle, from a closed or lowered position shown in FIG. 1, to a raised or open position (not shown). The ability to rotate the intake 100 upward in this manner allows a user to clear material that may be jammed in, or otherwise obstructing the exit portion of the intake 100.

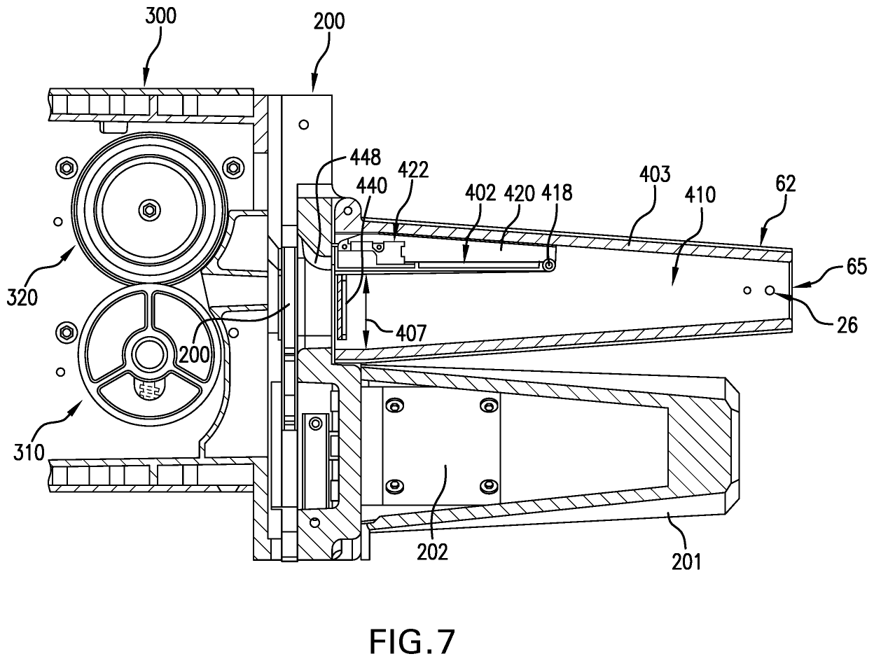

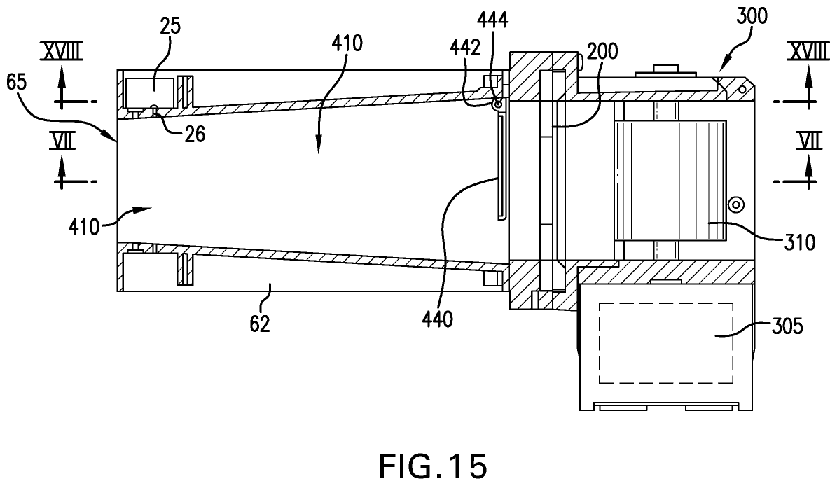

The dunnage machine 60 also includes a drive assembly 300, visible in FIGS. 7, 8, 15, and 16. The drive assembly 300 includes the feed motor 305 (shown schematically in FIG. 15), and rollers 310, 320. The rollers 310, 320 are configured to drive the stock material 19 through the dunnage machine 60, convert the stock material 19 into dunnage 15, and push the dunnage 15 into the outlet chute 62.

The intake 100 includes a guide having an inlet end for receiving the stock material 19 from the supply unit 18, and an outlet end through which the stock material 19 passes as it exits the intake 100 while traveling within, and through the intake 100, along a portion of the material path A. The jam detection device 400 can be used as part of dunnage producing systems having intakes with configurations different than that depicted in the figures.

The rollers 310, 320 are depicted in FIGS. 7, 8, 15, and 16. The rollers 310, 320 are configured to compress and crumple the stock material 19 entering the dunnage machine 60, convert the stock material 19 into dunnage 15, and transport the dunnage 15 through, and out of the dunnage machine 60. In particular, the rollers 310, 320 are configured to pull the stock material 19 from the inlet supply 18 and through intake 100; crumple and otherwise deform the stock material 19 as it passes between the rollers 310, 320; and then push the newly-formed dunnage 15 downstream, through the cutting mechanism 200 and into the outlet chute 62. Details of the rollers 310, 320 are presented for illustrative purposes only. The jam detection device 400 can be used in conjunction with rollers having other configurations, and with dunnage machines that crumple and deform stock material 19 using means other than rollers.

The roller 320 is driven in rotation by the feed motor 305. The roller 310 is idle, i.e., the roller 310 is not driven by a motor. The roller 310 is biased toward the roller 320, and is driven to rotate by interaction with the rotating roller 320 via an outer surface of the roller 310. In alternative embodiments, the roller 310 can be driven by a motor of the drive assembly 300.

The outer surface of the roller 310 is substantially smooth. The roller 320 has a shape or profile different than that of the roller 310. For example, an outer surface of the roller 320 can have grooves formed thereon. The grooves receive toroid-shaped ridges (not shown).

During operation of the dunnage machine 60, the stock material 19 is drawn by, and between the rollers 310, 320, from the supply station 13 and via the intake 100. The ridges on the roller 320, and the opposing outer surface of the roller 310 exert a pressure against the stock material 19. The pressure crumples and otherwise deforms the stock material 19 and increases the volume of the stock material 19, converting the stock material 19 into the dunnage.

FIGS. 2 and 3 depict the cutting mechanism 200 of the dunnage machine 60, coupled to the frame 63. FIGS. 2 and 3 depict the dunnage machine 60 without the enclosure 61, for clarity of illustration. The cutting mechanism 200 includes: a cutting motor assembly 201 having a cutting motor 202; a cover 210; a crank; a shuttle 230; magnets 203; a cutting portion 220; and an anvil portion 240.

The crank includes a crank arm 204 that is rotated by the cutting motor assembly 201. As can be seen in FIGS. 2-6, the shuttle 230 has a guide slot 231 formed therein and configured to receive an end portion of the crank arm 204, so that the crank arm 204 can translate between the ends of the guide slot 231 as the crank rotates. The engagement of the rotating crank arm 204 and the shuttle 230 imparts linear movement to the shuttle 230 in a cutting direction B.

The cover 210 defines a recess configured to receive the crank, and a space within the cover 210 to receive the shuttle 230. The shuttle 230 is configured to engage the cutting portion 220 so that movement of the shuttle 230 imparts a corresponding movement to the cutting portion 220.

The cutting portion 220 is held against the anvil portion 240, which is mounted on the frame 63 and remains stationary in relation the cutting portion 220, by the magnets 203. The magnets 203 permit the cutting portion 220 to slide along the contacting surface of the anvil portion 240, in the cutting direction B.

The cutting portion 220 has a cutting edge 223. A leading end of the cutting edge 223 has a sharp tip that helps the cutting edge 223 to efficiently initiate a cut in the dunnage 15, and to center and pin the dunnage 15 so that the dunnage 15 does not become crowded to one side. Such crowding could cause the dunnage 15 to form a bundle, which in turn could make it difficult to cut the dunnage 15.

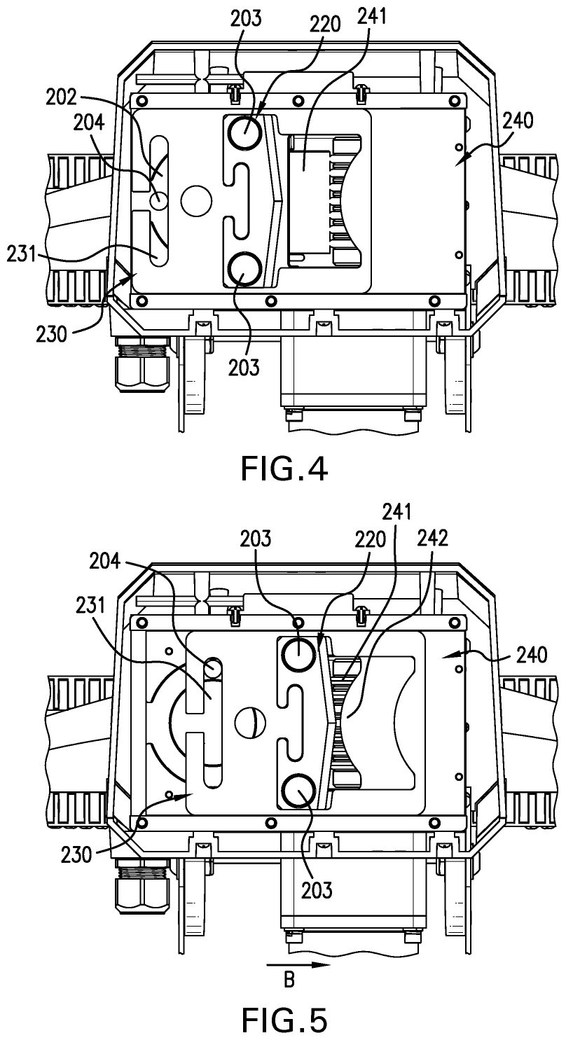

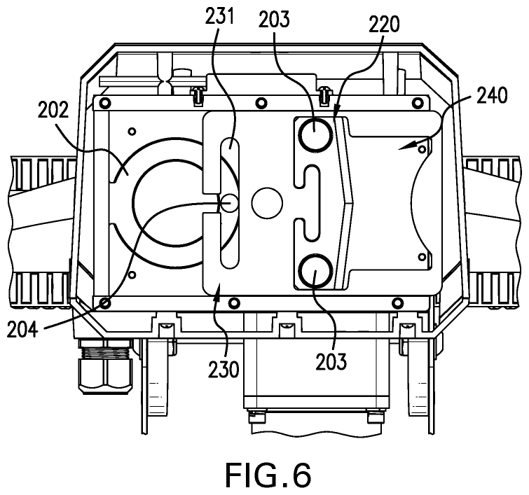

In the assembled state, the cutting portion 220 and the anvil 242 define a window 241 through which the dunnage 15 passes after being converted by the drive mechanism 300. The window 241 is denoted in FIGS. 4, 5, and 20. The cutting mechanism 200 can move from a home position (shown in FIGS. 3 and 4), through an intermediate position (without stopping) (shown in FIG. 5), and to end position (shown in FIG. 6), in response to rotation of the crank arm 204. In the home position, the cutting portion 220 is at the farthest distance from the anvil 242, and the window 241 is at its largest size. As the cutting mechanism 200 moves toward, and past its intermediate position and the cutting portion 220 moves in the cutting direction B, the window 241 decreases in size. When dunnage 15 is located within the window 241, as during normal operation of dunnage machine 60, the cutting edge 223 initiates a cut to the dunnage 15 when the cutting mechanism 200 is in its intermediate position approximately.

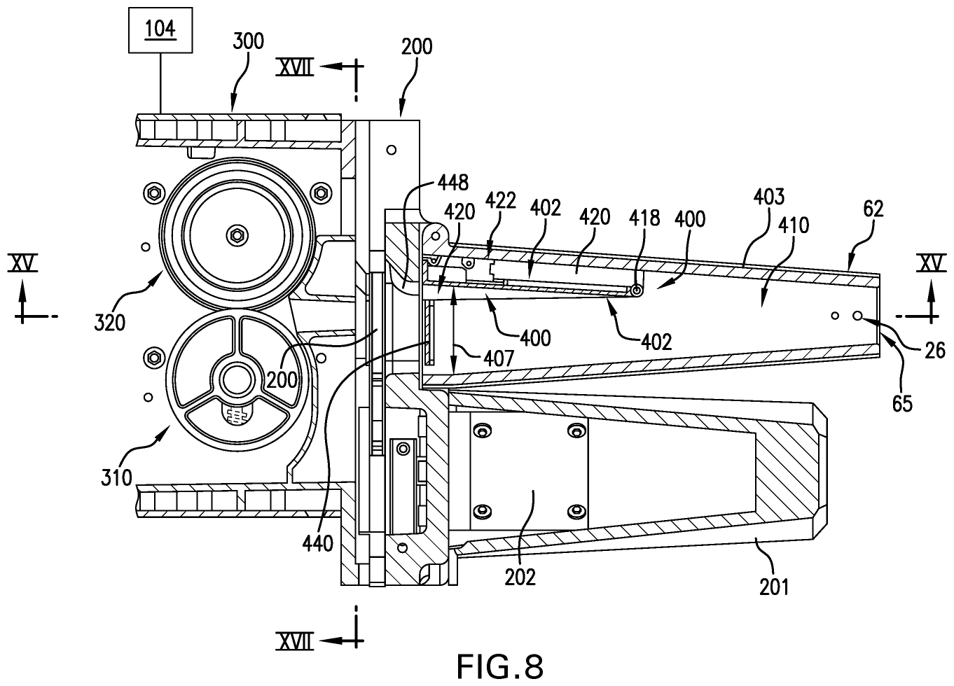

FIG. 6 depicts the cutting mechanism 200 in its end position. The window 241 previously defined between the cutting portion 220 and the anvil 242 has closed, i.e., no longer exists, due to the movement of the cutting portion 220 past the anvil 242. The dunnage 15 that was located within the window 241 has been pushed against the anvil 242 and severed by the cutting portion 220 as the cutting portion 220 advances in the cutting direction B to the position shown in FIG. 6. Thus, the portion of the dunnage 15 that advanced through the window 241 following the previous cutting cycle has been severed to form a separate piece of dunnage 15. The newly-cut piece of dunnage 15 can then exit the dunnage machine 60 by way of an exit 65 of the outlet chute 62. As discussed below, in the event one or more of the pieces of dunnage 15 become jammed in the outlet chute 62, the jam detection device 400 detects the presence of the jam, and generates an output that causes a controller 64 of the device 10 to interrupt operation of the dunnage machine 60 until the jam is cleared. The controller 64 is depicted schematically in FIG. 8.

After the cutting mechanism 200 has reached the end position, the continued rotation of the crank arm 204 eventually causes the crank arm 204 to return to its home position.

Details of the cutting mechanism 200 are presented for illustrative purposes only. The jam detection device 400 can be used in conjunction with other types of separators, in conjunction with cutting mechanisms having configurations other that of the cutting mechanism 200, and in dunnage devices in which the dunnage is severed by means other than cutting, such as tearing, the focused application of heat, etc.

Additional details of the supply unit 18 and the dunnage apparatus 50 can be found in U.S. application Ser. No. 18/340,805, the contents of which are incorporated by reference herein in their entirety.

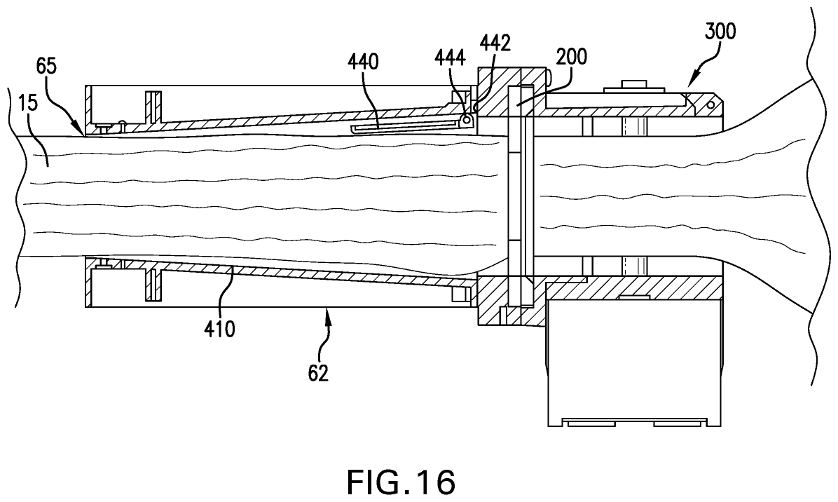

The system 110 further includes an optical sensor 25. The optical sensor 25 is depicted in FIG. 16. The optical sensor 25 is mounted on the outlet chute 62, and is optically coupled to the interior volume 410 of the outlet chute 62 via a hole 26 in the outlet chute 62, so that the sensor 25 can detect the presence, or absence, of dunnage 15 within the interior volume 410. The sensor 25 is communicatively coupled to the controller 64. The controller 64 is configured to activate the drive assembly 300 and the cutting mechanism 200 to produce another piece of dunnage 15 in the above-describe manner when the sensor 25 indicates that a piece of dunnage 15 is not present in the outlet chute 62, so that a piece of dunnage 15 is continually available to the user. Upon receiving an input from the sensor 25 indicating that a piece of dunnage 15 is present in the outlet chute 62, the controller 64 will maintain the drive assembly 300 and the cutting mechanism 200 in a deactivated state. Alternative embodiments of the device 10 can be configured without the sensor 25. For example, such systems can be activated manually, and can continually produce pieces of dunnage 15 while activated.

The jam detection device 400 is incorporated into the outlet chute 62. The outlet chute 62 is mounted on the dunnage machine 60, downstream of the cutting mechanism 200. The outlet chute 62 has a forward, or upstream end that defines an inlet of the outlet chute 62. The inlet is aligned with the window 241 defined by the cutting portion 220 and the anvil 242 of the cutting mechanism 200. The inlet receives the paper dunnage 15 after the dunnage 15 has been converted by the drive mechanism 300, and permits the dunnage 15 to pass into an interior volume 410 of the outlet chute 62. Once the dunnage 15 has been cut by the cutting mechanism 200 as described above, the resulting piece of dunnage 15 located within the interior volume 410 can be extracted, or pulled from the outlet chute 62 by the user or an automated mechanism, by way of the exit 65 defined by a downstream end of the outlet chute 62.

As discussed below, in the event one or more of the pieces of dunnage 15 become jammed in the outlet chute 62, the jam detection device 400 detects the presence of the jam, and generates an output that, when received by the controller 64, causes the dunnage machine 60 to cease operating until the jam is cleared.

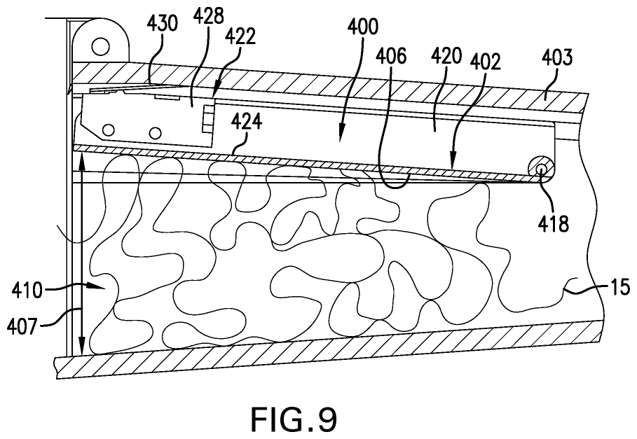

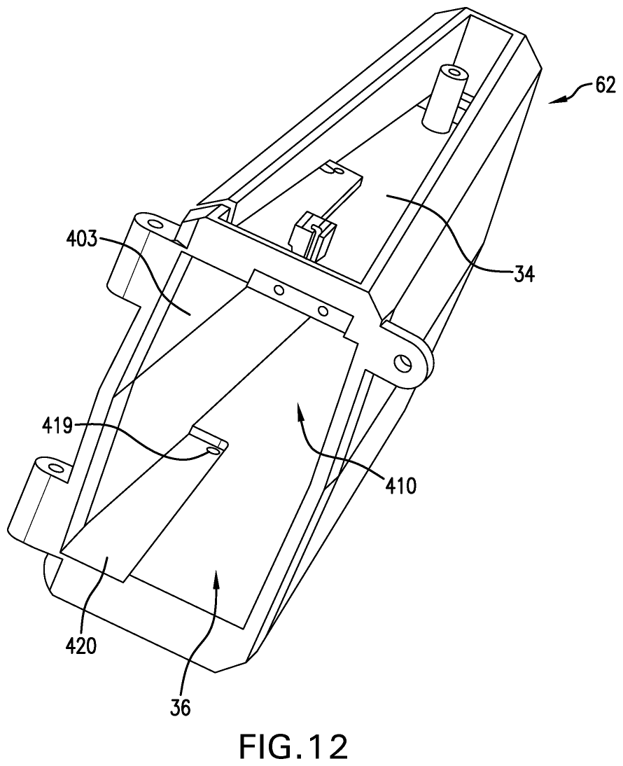

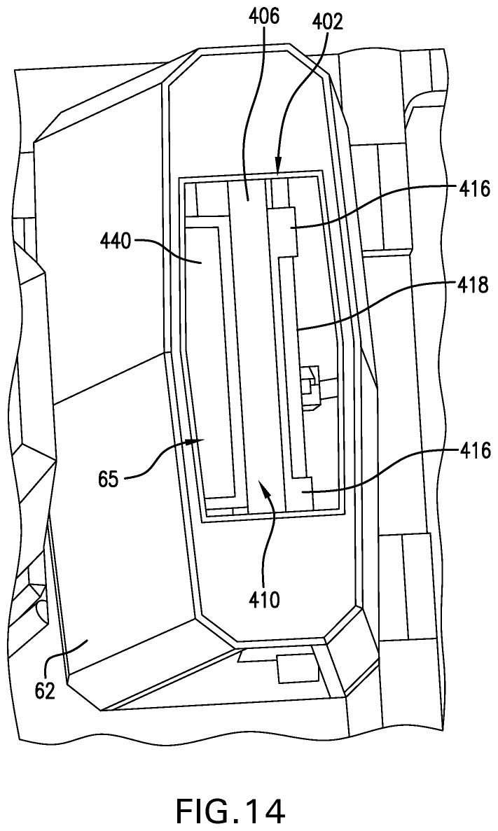

Referring to FIGS. 7-11, the jam detection device 400 includes a movable member in the form of a plate or flap 402. The flap 402 is located within the interior volume 410 of the outlet chute 62. The flap 402 is mounted for rotation on an upper wall 34 and a lower wall 36 of the outlet chute 62, by way of a pin 418, as can be seen in FIGS. 9 and 14. The flap 402 is located adjacent a sidewall 403 of the outlet chute 62. The flap 402 can be coupled to the outlet chute 62 using other mounting configurations, in alternative embodiments.

The flap 402 comprises a body 404. The body 404 has a substantially planar major surface 406 that faces inward, toward the centerline of the outlet chute 62. The body 404 also includes an upper edge 408 and a lower edge 410 that each adjoin the major surface 406. The upper and lower edges 408, 410 are angled downward as they extend in the downstream direction, to match the downwardly-angled geometry of the adjacent surfaces of the outlet chute 62.

The body 404 further includes an upstream edge 412 and a downstream edge 414 that each adjoin the major surface 406. The upstream edge 412 and the downstream edge 414 each have a substantially vertical orientation.

The flap 402 is configured to rotate in relation to the sidewall 403 between a first, or inward position shown in FIG. 8, and a second, or outward position shown in FIGS. 7 and 9. Referring to FIGS. 7-9, the upstream end of the flap 402 is spaced from the opposite wall of the outlet chute 62 by a distance 407. The distance 407 when the flap 402 is in its inward position is less than the distance 407 when the flap 402 is in its outward position.

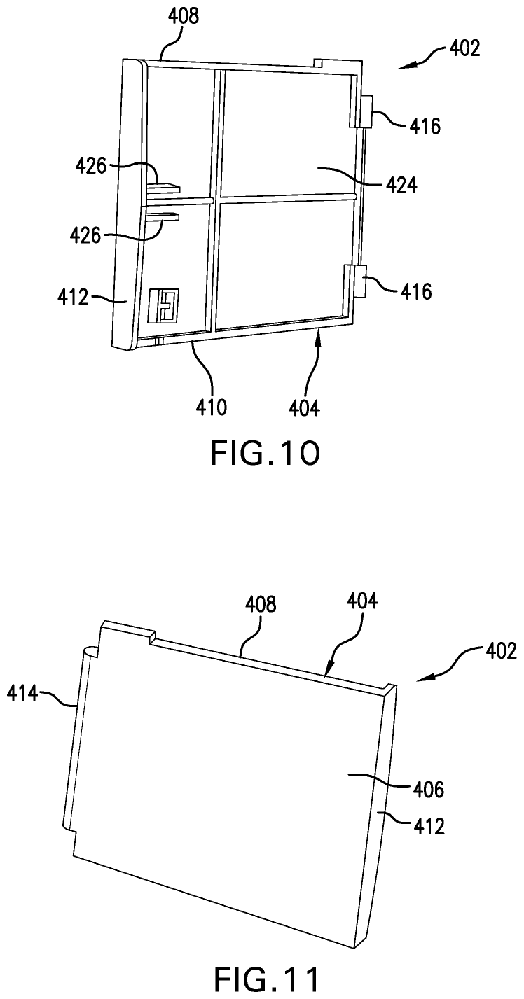

As can be seen in FIG. 10, the flap 402 includes two knuckles 416 that adjoin the downstream edge 414 of the body 404. The knuckles 416 are configured to receive the pin 418 with minimal clearance, so that the flap 402 can rotate smoothly on the pin 418. The ends of the pin 418 are received in respective holes 419 formed in the upper wall 34 and the lower wall 36 of the outlet chute 62. The ends of the pin 418 can be retained in the holes 419 by an interference fit or other suitable means. One of the holes 419 is visible in FIG. 12. The pin 418 has a substantially vertical orientation when installed on the outlet chute 62, so that the axis of rotation of the flap 402 is substantially vertical.

A recess 420 is formed in each of the upper wall 34 and the lower wall 36 of the outlet chute 62, as can be seen in FIG. 12. The recesses 420 face inward, toward the interior volume 410 of the outlet chute 62, and accommodate the body 404 of the flap 402 as the flap 402 rotates in relation to the outlet chute 62. The upper and lower portions of the body 404 are captured between the sidewall 403 of the outlet chute 62 and the lengthwise edges of the respective recesses 420. Also, the upper edge 408 and the lower edge 410 of the body 404 are located within the respective recesses 420 in the upper wall 34 and the lower wall 36, which in turn helps to prevent the dunnage 15 from catching, or being entrained between the upper and lower edges 408, 410 and the adjacent surfaces of the outlet chute 62.

The range of rotation of the flap 402 can be, for example, about 4.5 degrees. This specific value is presented for illustrative purposes only; the range of rotation of the flap 402 can be greater, or less than about 4.5 degrees in alternative embodiments.

The disclosure of the flap 402 as the movable member is disclosed for illustrative purposes only. The movable member can have other shapes and configurations in alternative embodiments.

The device 400 also includes a switch or sensor 422 mounted on the flap 402. The sensor 422 is electrically connected to the controller 64. The sensor 422 is mounted on a rear or back surface 424 of the body 404 of the flap 402, as can be seen in FIGS. 7 and 8. The back surface 424 is located on a side of the body 404 opposite the major surface 406. The flap 402 further includes two brackets 426 that extend from the back surface 424, as shown in FIG. 10. The brackets 426 are spaced apart, and define a space that receives the sensor 422. The sensor 422 can be securely snapped into the brackets 426. The sensor 422 can be secured to the flap 402 by other means, such as fasteners, in alternative embodiments.

Referring to FIGS. 7-9, the sensor 422 comprises a body 428, and an arm 430. The arm 430 is coupled to the body 428. The arm 430 is configured to rotate in relation to the body 428 between a first, or open position shown in FIG. 8, and a second, or closed position shown in FIGS. 7 and 9. The sensor 422 further includes a spring (not shown) positioned within the body 428 and configured to bias the arm 430 toward its first or open position. The bias on the arm 430 generated by the spring also biases the flap 402 toward its first or inward position. Alternative embodiments can include a separate spring to bias the flap 402 toward its inward position.

The sensor 422 further includes a throw and a contact (not shown) located within the body 428. The throw is connected to the arm 430. The throw is spaced apart from the contact when the arm 430 is in its open position. The throw is brought into physical contact with the contact when the arm 430 moved to its closed position, thereby establishing electrical contact between the throw and the contact. The electrical contact between the throw and the contact when the arm 430 is in its closed position causes the sensor 422 to generate an electrical output that is sent to the controller 64.

The sensor 422 is configured so that the arm 430 is in its closed position when the flap 104 is in its inward position; and the arm 430 is in its open position when the flap 104 is in its outward position. Thus, the controller 64 is configured to interpret a state in which the controller 64 is receiving an output signal from the sensor 422 as an indication that the flap 402 is in its outward position. Conversely, the controller 64 is configured to interpret a state in which the controller 64 is not receiving an output signal from the sensor 422 as an indication that the flap 402 is in its inward position.

The sensor 422 can have configurations other that the configuration described above. For example, the sensor 422 can be an optical sensor, a laser probe, an LVDT, an RVDT, a pressure transducer, a piezoelectric transducer etc.

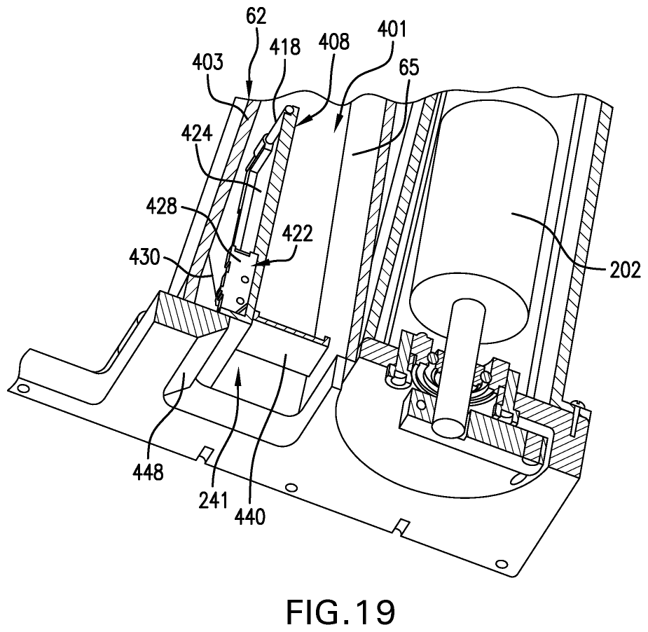

The jam detection device 400 also includes a guide 448 mounted on the outlet chute 62, directly upstream of the upstream edge 412 of the flap 402. The guide 448 is visible in FIGS. 7, 8, and 19. The guide 448 and the upstream edge 412 cooperate to inhibit cuttings and other debris from entering the cavity or volume defined by the back surface 424 of the flap 402, and the adjacent surface of the sidewall 403 of the outlet chute 62. Such debris, if allowed to enter the cavity, could interfere with the proper operation of the sensor 422.

The device 400 is configured to sense a paper jam in the outlet chute 62, downstream of the cutting mechanism 200; and to generate an output that, when received by the controller 64, causes the controller 64 to interrupt operation of the dunnage machine 60 until the paper jam is cleared. More specifically, the flap 402 is biased toward its first or inward position, as noted above. When the paper dunnage 15 fed into the outlet chute 62 by dunnage machine 60 after being cut, the lateral or side to side dimension of the dunnage 15 is sufficiently small so that forceful contact between the dunnage 15 and the flap 402 does not occur. The flap 402 thus remains in its first or inward position; the arm 430 of the sensor 422 remains in its open position; the throw and the contact of the sensor 422 remain out of physical and electrical contact; and the controller 64 interprets the absence of an electrical signal from the sensor 422 as an indication that a paper jam is not present in the outlet chute 62.

When the paper dunnage 15 jams within the chute 62, the continued feeding of the dunnage 15 from the dunnage machine 60 forces the dunnage 15 within the chute 62 into a side to side or zigzag pattern, as depicted in FIG. 9. The lateral movement of the dunnage 15 causes the dunnage 15 to forcefully contact the inwardly-facing major surface 406 of the flap 104, which in turn causes the flap 402 to rotate to its second or outward position. The rotation of the flap 402 to its outward position causes the arm 430 to move from its open position and to its closed position, thereby establishing physical and electrical contact between the throw and the contact of the sensor 422. The resulting electrical output of the sensor 422, when received by the controller 64, causes the controller 64 to interrupt operation of the dunnage machine 60.

The controller 64 will prevent the dunnage machine 60 from restarting until the controller 64 no longer receives the signal from the sensor 422 indicating the presence of a paper jam in the outlet chute 62. Once the operator clears the paper jam from the outlet chute 62 and the jammed paper dunnage 15 no longer contacts the flap 402, the inward bias of the sensor 422 on the flap 402 causes the flap 402 to return to its first or inward position, which in turn causes the throw to separate from the contact of the sensor 422. At this point, the controller 64, which no longer is receiving the output signal of the sensor 422, will permit the dunnage machine 60 to resume operation once the operator presses a reset button (not shown). Alternative embodiments can be configured without a reset button. The substantially flat configuration of the flap 402, and the substantial alignment of the major surface 406 of the flap 402 with the normal direction of travel of the dunnage 15 through the outlet chute 62, allow the operator to pull the jammed dunnage 15 from the interior volume of the outlet chute 62 without interference from the jam detection device 400.

In alternative embodiments, the device 400 can be configured so that the dunnage 15 acts directly on the sensor 422. For example, the sensor 422 can be configured as a pressure transducer or a piezoelectric transducer that generates an output in response to pressure exerted directly on the sensor 422 by the jammed dunnage 15. In such embodiments, the device 400 can be configured without a movable member such as the flap 402. In other alternative embodiments, the sensor 422 can be configured to directly interrupt the supply of electric power to the feed motor 305 when the sensor 422 registers the presence of a jam.

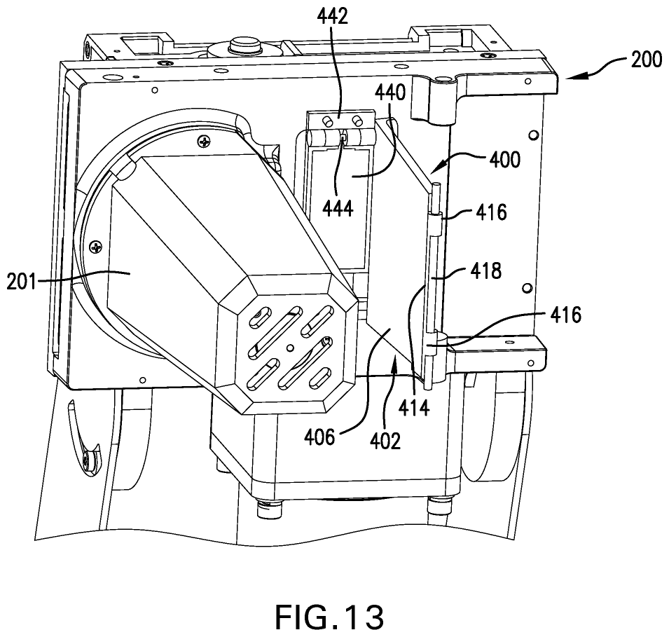

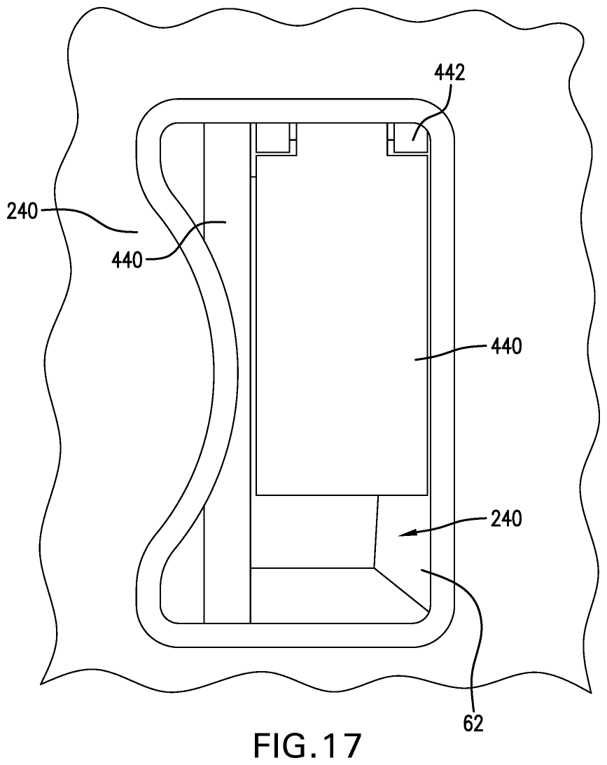

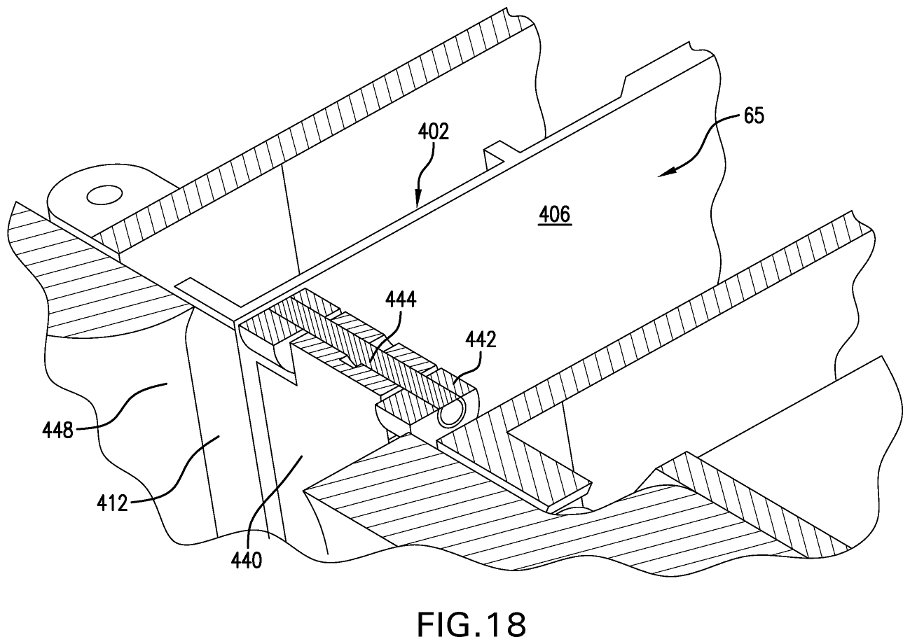

The outlet chute 62 can include a door or gate 440, shown in FIGS. 13-19. The gate 440 is suspended from a bracket 442, and is aligned with the window 241 defined between the cutting portion 220 and the anvil 242.

The gate 440 is connected to the bracket 442 by way of a pin 444 that permits the gate 440 to rotate in relation to the bracket 442 and the forward wall 444. The gate 440 has a height, or vertical dimension, that is less than the height of the window 241. The gate 440 is depicted in FIGS. 13-15 and 17-19 in a closed position at which the gate 440 covers a portion of the inlet to the outlet chute 62.

The gate 440 is biased toward the closed position by a torsion spring (not shown) disposed around the pin 444. The bracket 442 is configured to limit rotation of the gate 440 past the closed position.

The downstream movement of the dunnage 15 into the outlet chute 62 urges the gate 440 to rotate away from its closed position, toward the interior volume 410 and against the bias of the spring, by about 90 degrees, and to an open position depicted in FIG. 16. More specifically, the downstream movement of the dunnage 15 causes the dunnage 15 to exert a drag on the gate 440, with the drag being increased by the bias exerted by the torsion spring on the gate 440. This drag rotates the gate 440 away from its closed position. When in the open position, the gate 440 does not interfere with the passage of the dunnage 15 into the interior volume 410. The bias of the spring causes the gate 440 to exert a downward force on the dunnage 15. Once the dunnage 15 has been cut by the cutting mechanism 200, the gate 400, due to its spring bias, will continue to exert a force on the dunnage 15. This force acts as a clamping force that holds the piece of dunnage 15 in place until the operator or other user pulls the downstream end of the piece of dunnage 15 to remove the piece for the outlet chute 62. Once the piece of dunnage 15 has been removed from the outlet chute 62, the gate 440 will return to its closed position under the bias of the spring.

Alternative embodiments of the outlet chute 62 can be configured without the gate 440.

One having ordinary skill in the art should appreciate that there are numerous types and sizes of dunnage for which there can be a need or desire to produce, accumulate, and/or discharge, and the device 400, and alternative embodiments thereof, can be used in connection with alternate embodiments of the device 10 configured to produce such dunnage.

As used herein, the terms “top,” “bottom,” and/or other terms indicative of direction are used herein for convenience and to depict relational positions and/or directions between the parts of the embodiments. It will be appreciated that certain embodiments, or portions thereof, can also be oriented in other positions. In addition, the term “about” should generally be understood to refer to both the corresponding number and a range of numbers. In addition, all numerical ranges herein should be understood to include each whole integer within the range.

Although certain features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents. Also, while illustrative embodiments of the invention are disclosed herein, it will be appreciated that numerous modifications and other embodiments may be devised by those skilled in the art. For example, the features for the various embodiments can be used in other embodiments, and the appended claims are intended to cover all such modifications and embodiments that come within the spirit and scope of the present invention.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or methods are in any way required for one or more implementations or that these features, elements, and/or methods are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

We claim:

1. A device for producing dunnage, comprising:
an outlet chute configured to receive the dunnage and direct the dunnage to an exit of the device;
a dunnage mechanism configured to deform a stock material into the dunnage and to drive the dunnage into and through the outlet chute to the exit; and
a jam detector associated with the outlet chute and sensitive to detect a dunnage jam within the outlet chute, wherein the jam detector is further associated with the dunnage mechanism to cause the dunnage mechanism to stop driving the dunnage into the outlet chute when the jam is detected.

2. The device of claim 1, wherein the jam detector comprises a switch configured to be deflected by an accumulation of the dunnage.

3. The device of claim 1, wherein the jam detector further comprises a member comprising a movable surface exposed to an interior of the outlet chute, such that the accumulation of the dunnage caused by the jam depresses the movable surface so that the member deflects the switch.

4. The device of claim 1, wherein the dunnage mechanism is further configured to crumple the stock material into the dunnage.

5. The device of claim 1, further comprising a controller operably connected to the dunnage mechanism and the jam detector, wherein the controller is configured to control the driving of the dunnage.

6. The device of claim 5, wherein the controller is further configured to prohibit operation of the dunnage mechanism when the jam is detected.

7. The device of claim 1, wherein the outlet chute is further configured to shape the dunnage as the dunnage is directed to the exit of the device.

8. The device of claim 7, wherein:
the outlet defines an interior volume that adjoins the exit; and
a cross-sectional area of the interior volume decreases between an inlet of the interior volume and the exit.

9. The device of claim 8, wherein a width of the interior volume decreases between the inlet of the interior volume and the exit.

10. The device of claim 8, wherein a height of the interior volume decreases between the inlet of the interior volume and the exit.

11. The device of claim 1, further comprising a separator configured to separate a piece of the dunnage from a remainder of the dunnage.

12. The device of claim 11, wherein the separator comprises a cutting mechanism.

13. The device of claim 12, wherein the cutting mechanism comprises a blade configured to cut the dunnage.

14. The device of claim 3, wherein the member comprises a flap.

15. The device of claim 1, wherein the drive mechanism comprises one or more rollers configured to deform the stock material into the dunnage.

16. The device system of claim 11, further comprising a gate positioned at an inlet of the outlet chute and configured to retain the piece of dunnage after the piece of dunnage has been separated by the separator.

17. The device of claim 16, wherein:
the gate is movable between a first position at which the gate covers at least a portion of the inlet, and a second position; and
the gate is biased toward the first position.

18. The device of claim 3, wherein the member is further configured so that movement of the dunnage within the outlet chute in a direction transverse to a lengthwise direction of the outlet chute depresses the movable surface.

19. A dunnage system, comprising:
a unit of stock material;
a supply station configured to hold the unit of stock material; and
a device for producing dunnage, comprising:
an outlet chute configured to receive the dunnage and direct the dunnage to an exit of the device;
a dunnage mechanism configured to deform a stock material into the dunnage and to drive the dunnage into and through the outlet chute to the exit; and
a jam detector associated with the outlet chute and sensitive to detect a dunnage jam within the outlet chute, wherein the jam detector is associated with the dunnage mechanism to cause the dunnage mechanism to stop driving the dunnage into the outlet chute when a jam is detected.

20. The system of claim 19, wherein the stock material comprises paper.
